(19) United States
(12) Patent Application Publication
(10) Pub. No.: US 2026/0348334 A1
(43) Pub. Date: Nov. 5, 2026

(54) METHOD OF OPERATING A COMBUSTION ENGINE, COMPUTER PROGRAM, COMPUTER-READABLE MEDIUM, CONTROL ARRANGEMENT, COMBUSTION ENGINE, AND VEHICLE

(71) Applicant: Scania CV AB, Södertälje (SE)

(72) Inventors: Martin BERGLUND, Vagnhärad (SE); Karl VESTGÖTE, Nyköping (SE); Daniel STÅHL, Enköping (SE); Henrik ANDERSSON, Lidingö (SE); Hans GÖRANSSON, Älvsjö (SE)

(73) Assignee: Scania CV AB, Södertälje (SE)

(21) Appl. No.: 19/120,331

(22) PCT Filed: Oct. 12, 2023
(86) PCT No.: PCT/EP2023/078387

§ 371 Date: Apr. 11, 2025

(30) Foreign Application Priority Data
Oct. 19, 2022 (EP) 22202354.1

(51) Int. Cl. F02D 41/00; F02D 41/12

(52) U.S. Cl. CPC F02D 41/0087; F02D 41/123

(57) ABSTRACT

A method of operating an internal combustion engine is disclosed, the internal combustion engine comprising a plurality of cylinders. The method comprises the steps of operating a first set of cylinders in a compression release mode, operating a second set of cylinders in a motoring mode, and initiating operation of a power mode of the second set of cylinders upon receipt of a compression release mode deactivation demand. The present disclosure further relates to a computer program, a computer-readable medium, a control arrangement, an internal combustion engine, and a vehicle.

### TECHNICAL FIELD

The present disclosure relates to a method of operating an internal combustion engine. The present disclosure further relates to a computer program, a computer-readable medium, a control arrangement for an internal combustion engine, an internal combustion engine comprising a plurality of cylinders and a control arrangement, as well as a vehicle comprising an internal combustion engine.

### BACKGROUND

Internal combustion engines, such as four-stroke internal combustion engines, comprise one or more cylinders and a piston arranged in each cylinder. The pistons are connected to a crankshaft of the engine and are arranged to reciprocate within the cylinders upon rotation of the crankshaft. The engine usually further comprises one or more inlet valves and outlet valves as well as one or more fuel supply arrangements. The one or more inlet valves and outlet valves are controlled by a respective valve control arrangement usually comprising one or more camshafts rotatably connected to a crankshaft of the engine, via a belt, chain, gears, or similar. A four-stroke internal combustion engine completes four separate strokes while turning a crankshaft. A stroke refers to the full travel of the piston along the cylinder, in either direction. The uppermost position of the piston in the cylinder is usually referred to as the top dead centre TDC, and the lowermost position of the piston in the cylinder is usually referred to as the bottom dead centre BDC.

The strokes are completed in the following order, inlet stroke, compression stroke, expansion stroke and exhaust stroke. During operation of a conventional four-stroke internal combustion engine, the inlet valve control arrangement controls inlet valves of a cylinder to an open state during the inlet stroke of a piston within the cylinder, to allow air, or a mixture of air and fuel, to enter the cylinder. During the compression stroke, all valves should be closed to allow compression of the air, or the mixture of the air and fuel, in the cylinder. If the engine is in a power producing state, fuel in the cylinder is ignited, usually towards the end of the compression stroke, for example by a spark plug or by compression heat in the cylinder. The combustion of fuel within the cylinder significantly increases pressure and temperature in the cylinder. The combustion of the fuel usually continues into a significant portion of the subsequent expansion stroke. The increased pressure and temperature in the cylinder obtained by the combustion is partially converted into mechanical work supplied to the crank shaft during the expansion stroke. Obviously, all valves should remain closed during the expansion stroke to allow the increased pressure and temperature to be converted into mechanical work. The expansion stroke is also usually referred to as the combustion stroke, since usually, most of the combustion takes place during the expansion stroke. In the subsequent exhaust stroke, the exhaust valve control arrangement controls exhaust valves of the cylinder to an open state to allow exhaust gases to be expelled out of the cylinder into an exhaust system of the combustion engine.

During motoring, occurring for example when a driver of a vehicle releases an accelerator pedal, the engine will continue to operate in the above described strokes, with the exception that no fuel is supplied to the engine during motoring, and consequently, no combustion will take place during the end of the compression stroke or during the expansion stroke. In this condition, the engine will provide some braking torque due to internal friction and due to the pumping of air from the inlet to the exhaust, in the respective inlet stroke and exhaust stroke. As a piston travels upward during its compression stroke, the gases that are trapped in the cylinder are compressed. The compressed gases oppose the upward motion of the piston. However, almost all the energy stored in the compressed gases is returned to the crank shaft on the subsequent expansion stroke. Thereby, during motoring, the compression stroke together with the subsequent expansion stroke, will not contribute to a significant braking torque of the engine.

Some legislations require heavier vehicles to be provided with an auxiliary braking system in addition to wheel brakes. An efficient means of braking the vehicle is to utilize an engine to provide extra braking force because already existing systems of the vehicle can be utilized to generate the braking force needed and to transport the heat generated during braking to the surroundings. Moreover, the use of an engine to provide extra braking force reduces wear of the wheel brakes.

There are some different types of methods and arrangements for increasing the braking torque of an engine. A compression release engine brake, sometimes referred to a Jake brake, Jacobs brake, or CRB (for Compression Release Brake), is an engine braking mechanism used in some engines. Some compression release brake arrangements comprise a valve actuator assembly which is configured to open exhaust valves in the cylinders after the compression stroke to release the compressed air trapped in the cylinders to the exhaust system. Thereby, the energy stored in the compressed gases during the compression stroke will not be returned to the crank shaft in the subsequent expansion stroke, which increases the braking torque of the engine. Some compression release engine brake arrangements comprise a hydraulic arrangement which actuates the valve actuator assembly by supplying a hydraulic pressure to the valve actuator assembly.

Compression release engine brakes are today a commonly used as an auxiliary brake in heavy duty vehicles such as trucks equipped with internal combustion engines. An effective compression release engine brake can in many applications replace a retarder, which can save cost, complexity, and weight of the vehicle. However, a problem associated with compression release engine brake arrangements is that it may take considerable time to deactivate compression release braking, especially in some situations and during some conditions. A relative long deactivation time of compression release engine braking impair the driving feel of the vehicle. Furthermore, it can impair the functionality of an anti-lock braking system ABS because these types of system normally need to quickly reduce a braking torque to avoid or counteract wheel slip.

Some legislation enables having a trailer connected to the vehicle and is met by being able to maintain a certain speed with a certain vehicle weight in a slope having a predetermined inclination and length. To meet this type of legislation with vehicles equipped with compression release engine brake as main auxiliary brake, it is important that the compression release engine brake is operational in a wide range of vehicle and ambient temperatures.

For example, this type of legislation can be met with a cold vehicle due to the increased drag losses in propulsion system, driven and non-driven axles etc., but as the losses decrease with increased temperature, it may be essential that the compression release engine brake is operational before the drag losses decrease so much that the legislation is no longer met without utilizing the compression release engine brake.

As mentioned, the relatively long deactivation time of compression release engine braking can impair the functionality of an anti-lock braking system and a fast enough deactivation of the compression release engine brake can be hard to achieve under certain conditions. This in turn leads to that utilization of the compression release engine brake must be delayed until the compression release engine brake deactivation time is below a certain threshold time. As a result, the legislation may not be met when the total braking power is too low due to decreased drag losses during warm up of the vehicle. Therefore, the vehicle may have to be provided with another type of auxiliary braking system, such as a hydraulic retarder or the like, to be able to comply with the legislation. Such an auxiliary braking system adds costs, complexity, and weight to the vehicle.

### SUMMARY

It is an object of the present invention to overcome, or at least alleviate, at least some of the above-mentioned problems and drawbacks.

According to a first aspect of the invention, the object is achieved by a method of operating an internal combustion engine, the internal combustion engine comprising a plurality of cylinders, wherein the method comprises the steps of:
operating a first set of cylinders of the plurality of cylinders in a compression release mode,
operating a second set of cylinders of the plurality of cylinders in a motoring mode, and
initiating operation of a power mode of the second set of cylinders of the plurality of cylinders upon receipt of a compression release mode deactivation demand.

Thereby, a method is provided having conditions for obtaining a quick reduction in negative crankshaft torque upon receipt of the compression release mode deactivation demand. That is, by operating the second set of cylinders of the plurality of cylinders in the motoring mode during the operation of the first set of cylinders in the compression release mode, a quick initiation of the power mode of the second set of cylinders can be provided upon receipt of the compression release mode deactivation demand so as to quickly reduce the negative crankshaft torque provided by the first set of cylinders.

Accordingly, due to these features, a method is provided allowing the use of compression release engine braking in a wider range of situations and conditions. Moreover, due to these features, a method is provided having conditions for facilitating compliance with legislation while circumventing, or at least reducing, the need for further auxiliary brakes on the vehicle, such as one or more retarders, or the like.

In addition, since conditions are provided for a quick reduction in negative crankshaft torque upon receipt of the compression release mode deactivation demand, the method provides conditions for avoiding wheel slip, especially in slippery road conditions. In other words, due to the features of the method, compression release engine braking can be performed in a safer and more efficient manner also in vehicles comprising a driving aid system, such as an anti-lock braking system, and the like.

Furthermore, since conditions are provided for a quick reduction in negative crankshaft torque upon receipt of the compression release mode deactivation demand, an improved driving feel of the vehicle can be provided with a quicker response and feedback to a driver, for example when the driver release a brake pedal or other type of input device for cancelling compression release engine braking.

Accordingly, a method is provided overcoming, or at least alleviating, at least some of the above-mentioned problems and drawbacks. As a result, the above-mentioned object is achieved.

Optionally, the method comprises the step of:
initiating a deactivation of the compression release mode of the first set of cylinders upon receipt of the compression release mode deactivation demand.

Thereby, a simultaneous initiation of deactivation of the compression release mode of the first set of cylinders and an initiation of operation of the power mode of the second set of cylinders can be provided upon receipt of the compression release mode deactivation demand. Moreover, since the method comprises the step of initiating operation of the power mode of the second set of cylinders of the plurality of cylinders upon receipt of the compression release mode deactivation demand, the negative torque generated by the first set of cylinders can be compensated for during a deactivation phase of the compression release mode of the first set of cylinders.

Optionally, the method comprises the step of:
operating the second set of cylinders in the power mode during a deactivation phase of the compression release mode of the first set of cylinders.

Thereby, the negative crankshaft torque obtained from the first set of cylinders can be compensated for during the full deactivation phase of the compression release mode of the first set of cylinders. In this manner, a method is provided having further improved conditions for allowing the use of compression release engine braking in a wider range of situations and conditions. Moreover, a method is provided having further improved conditions for facilitating compliance with legislation while circumventing, or at least reducing, the need for further auxiliary brakes on the vehicle, such as one or more retarders, or the like. In addition, a method is provided having further improved conditions for avoiding wheel slip and further improved conditions for providing an improved driving feel of the vehicle.

Optionally, the method comprises the step of:
cancelling operation of the second set of cylinders in the power mode at an end of the deactivation phase of the compression release mode of the first set of cylinders.

Thereby, conditions are provided for an at least substantially neutral crankshaft torque during a time period lasting from the receipt of the compression release mode deactivation demand to a time after the end of the deactivation phase of the compression release mode of the first set of cylinders.

Optionally, the step of operating the second set of cylinders in the power mode during the deactivation phase comprises the step of:
controlling operation of the second set of cylinders to generate a positive crankshaft torque having a magnitude of at least 25%, or at least 50%, of the magnitude of a negative crankshaft torque generated by the first set of cylinders during the deactivation phase.

Thereby, a significant reduction can be provided of the negative crankshaft torque generated by the first set of cylinders during the deactivation phase of the compression release mode. Optionally, the method comprises the steps of, prior to the step of operating the first set of cylinders in the compression release mode and the step of operating the second set of cylinders in the motoring mode:
estimating a duration of a deactivation phase of a compression release mode, and initiating operation of the first set of cylinders in the compression release mode and operation of the second set of cylinders in the motoring mode if the estimated duration exceeds a threshold duration.

Thereby, a method is provided in which the step of operating the first set of cylinders in the compression release mode and the step of operating the second set of cylinders in the motoring mode can be performed if determined necessary to obtain a short reduction time in the negative crankshaft torque obtained during compression release engine braking upon cancelling the compression release engine braking.

Optionally, the method may comprise the step of, if the estimated duration is shorter than the threshold duration and if a compression release mode activation demand is received:
initiating operation in a compression release mode of the plurality of cylinders of the internal combustion engine.

In this manner, compression release engine braking can be performed in all cylinders of the combustion engine if the estimated duration is shorter than the threshold duration and thereby is determined sufficiently short for obtaining a reduction in the negative crankshaft torque upon cancelling compression release engine braking.

Optionally, the step of estimating the duration of the deactivation phase of the compression release mode comprises the step of:
estimating the duration of the deactivation phase of the compression release mode based on data representative of at least one of a current coolant temperature of the combustion engine, a current oil temperature of the combustion engine, a current oil pressure of the combustion engine, a current ambient temperature, an elapsed time since a start-up of the combustion engine, an accumulated fuel flow since start-up of the combustion engine, a number of engine revolutions since start-up of the combustion engine, a distance travelled since start-up of the combustion engine, and energy obtained from the combustion engine since start-up of the combustion engine. Thereby, a reliable estimation can be provided in a simple and efficient manner of the duration of the deactivation phase of the compression release mode. This is because each of these types of data can, alone, or in combination, provide a reliable indication of the duration of the deactivation phase of the compression release mode.

According to a second aspect of the invention, the object is achieved by a computer program comprising instructions which, when the program is executed by a computer, cause the computer to carry out the method according to some embodiments of the present disclosure. Since the computer program comprises instructions which, when the program is executed by computer, cause the computer to carry out the method according to some embodiments, a computer program is provided which provides conditions for overcoming, or at least alleviating, at least some of the above-mentioned drawbacks. As a result, the above-mentioned object is achieved.

According to a third aspect of the invention, the object is achieved by a computer-readable medium comprising instructions which, when executed by a computer, cause the computer to carry out the method according to some embodiments of the present disclosure. Since the computer-readable medium comprises instructions which, when the program is executed by a computer, cause the computer to carry out the method according to some embodiments, a computer-readable medium is provided which provides conditions for overcoming, or at least alleviating, at least some of the above-mentioned drawbacks. As a result, the above-mentioned object is achieved.

According to a fourth aspect of the invention, the object is achieved by a control arrangement for an internal combustion engine, the internal combustion engine comprising a plurality of cylinders, wherein the control arrangement is configured to:
operate a first set of cylinders of the plurality of cylinders in a compression release mode,
operate a second set of cylinders of the plurality of cylinders in a motoring mode, and
initiate operation of a power mode of the second set of cylinders of the plurality of cylinders upon receipt of a compression release mode deactivation demand.

Thereby, a control arrangement is provided having conditions for obtaining a quick reduction in negative crankshaft torque upon receipt of the compression release mode deactivation demand. That is, by operating the second set of cylinders of the plurality of cylinders in the motoring mode during the operation of the first set of cylinders in the compression release mode, a quick initiation of the power mode of the second set of cylinders can be provided upon receipt of the compression release mode deactivation demand so as to quickly reduce the negative crankshaft torque provided by the first set of cylinders.

Accordingly, due to these features, a control arrangement is provided allowing the use of compression release engine braking in a wider range of situations and conditions. Moreover, due to these features, a control arrangement is provided having conditions for facilitating compliance with legislation while circumventing, or at least reducing, the need for further auxiliary brakes on the vehicle, such as one or more retarders, or the like.

In addition, since conditions are provided for a quick reduction in negative crankshaft torque upon receipt of the compression release mode deactivation demand, the control arrangement provides conditions for avoiding wheel slip, especially in slippery road conditions. In other words, due to the features of the control arrangement, compression release engine braking can be performed in a safer and more efficient manner also in vehicles comprising a driving aid system, such as an anti-lock braking system, and the like.

Furthermore, since conditions are provided for a quick reduction in negative crankshaft torque upon receipt of the compression release mode deactivation demand, an improved driving feel of the vehicle can be provided with a quicker response and feedback to a driver, for example when the driver release a brake pedal or other type of input device for cancelling compression release engine braking.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the invention, the object is achieved by an internal combustion engine comprising a plurality of cylinders and a control arrangement according to some embodiments of the present disclosure. Since the internal combustion engine comprises a control arrangement according to some embodiments, an internal combustion engine is provided overcoming, or at least alleviating, at least some of the above-mentioned problems and drawbacks. As a result, the above-mentioned object is achieved.

According to a sixth aspect of the invention, the object is achieved by a vehicle comprising an internal combustion engine according to some embodiments of the present disclosure.

Since the vehicle comprises an internal combustion engine according to some embodiments, a vehicle is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a vehicle according to some embodiments,

FIG. 2 schematically illustrates an internal combustion engine of the vehicle illustrated in FIG. 1,

FIG. 3 schematically illustrates a cross sectional view of the internal combustion engine illustrated in FIG. 2,

FIG. 4 schematically illustrates a method of operating an internal combustion engine,

FIG. 5 illustrates a graph showing when some method steps of the method illustrated in FIG. 4 are performed, and

FIG. 6 illustrates a computer-readable medium.

### DETAILED DESCRIPTION

Aspects of the present invention will now be described more fully. Like numbers refer to like elements throughout. Well-known functions or constructions will not necessarily be described in detail for brevity and/or clarity.

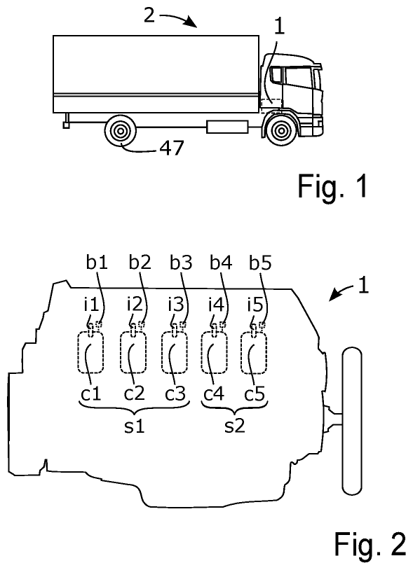

FIG. 1 illustrates a vehicle 2 according to some embodiments of the present disclosure. According to the illustrated embodiments, the vehicle 2 is a truck, i.e., a type of heavy vehicle. According to further embodiments, the vehicle 2, as referred to herein, may be another type of heavy or lighter type of manned or unmanned vehicle for land-based propulsion, such as a lorry, a bus, a construction vehicle, a tractor, a car, or the like.

The vehicle 2 comprises an internal combustion engine 1. According to the illustrated embodiments, the internal combustion engine 1 is configured to provide motive power to the vehicle 2 via wheels 47 of the vehicle 2. The vehicle 2 may comprise one or more electric propulsion motors in addition to the internal combustion engine 1 for providing motive power to the vehicle 2. Thus, the vehicle 2 may comprise a so-called hybrid electric powertrain comprising one or more electric propulsion motors in addition to the internal combustion engine 1 for providing motive power to the vehicle 2.

FIG. 2 schematically illustrates the internal combustion engine 1 of the vehicle 2 illustrated in FIG. 1. The internal combustion engine 1 comprises a plurality cylinders c1, c2, c3, c4, c5, i.e., comprises at least two cylinders c1, c2, c3, c4, c5. In FIG. 2, the cylinders c1, c2, c3, c4, c5 of the internal combustion engine 1 are schematically indicated. The reference signs for the cylinders c1, c2, c3, c4, c5 of the combustion engine 1 is in some places herein abbreviated “c1-c5” for reasons of brevity and clarity.

According to the illustrated embodiments, the internal combustion engine 1 comprises five cylinders c1-c5 arranged in one row. The internal combustion engine 1 according to the illustrated embodiments may therefore be referred to an inline five-cylinder engine. However, according to further embodiments, the internal combustion engine 1, as referred to herein, may comprise another number of cylinders c1-c5, wherein the number of cylinders c1-c5 is an integer higher than one. Moreover, the cylinders c1-c5 of the internal combustion engine 1 may be arranged in another configuration than in one row, such as in two or more rows.

Each cylinder c1-c5 of the internal combustion engine 1 comprises at least one fuel injector i1, i2, i3, i4, i5 configured to inject fuel into the cylinder c1-c5. The reference signs for the fuel injectors i1, i2, i3, i4, i5 of the combustion engine 1 is in some places herein abbreviated “i1-i5” for reasons of brevity and clarity. According to the illustrated embodiments, the combustion engine 1 comprises one fuel injector i1-i5 per cylinder c1-c5, wherein each fuel injector i1-i5 is configured to inject fuel directly into a cylinder c1-c5 of the internal combustion engine 1. According to further embodiments, the internal combustion engine 1 may comprise another number of fuel injectors i1-i5 per cylinder c1-c5.

According to the illustrated embodiments, the internal combustion engine 1 is a diesel engine, i.e., a type of compression ignition engine. The internal combustion engine 1 may thus be configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine 1, as referred to herein, may an Otto engine with a spark-ignition device, wherein the Otto engine may be configured to run on petrol, alcohol, similar volatile fuels, or combinations thereof. Alcohol, such as ethanol, can be derived from renewable biomass. According to embodiments herein, the internal combustion engine 1 is a four-stroke internal combustion engine 1. For reasons of brevity and clarity, the internal combustion engine 1 is in some places herein referred to as the “combustion engine 1” or simply the “engine 1”. Moreover, the internal combustion engine 1, as referred to herein, may be configured to power another type of unit or system than a vehicle, such as for example an electric generator.

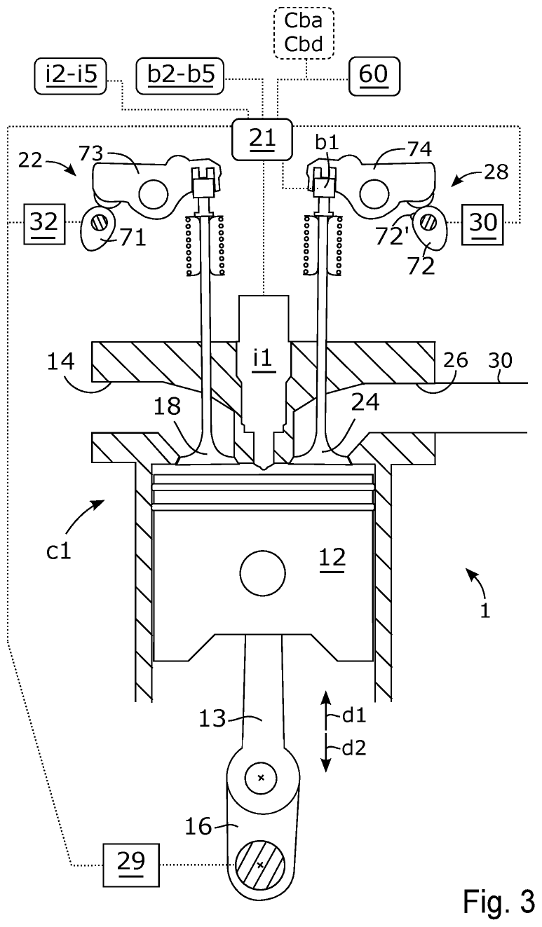

FIG. 3 schematically illustrates a cross sectional view of the internal combustion engine 1 illustrated in FIG. 2. In FIG. 3, the cross section is made in a plane comprising a centre axis of one of the cylinders c1 of the combustion engine 1. Below, simultaneous reference is made to FIG. 1-FIG. 3, if not indicated otherwise.

Each cylinder c1-c5 of the combustion engine 1 comprises the same features and functions as the other cylinders c1-c5 of the combustion engine 1. Therefore, FIG. 3 can be said to represent a cross section of one of the cylinders c1 of the combustion engine 1, wherein the cylinder c1 could be any of the cylinders c1-c5 of the combustion engine 1 illustrated in FIG. 2. However, for reasons of brevity and clarity, the reference sign “c1” is mostly used below to denote the cylinder c1 illustrated in FIG. 3.

The combustion engine 1 comprises a piston 12 arranged in each cylinder c1. The piston 12 is connected, via a connecting rod 13 to a crankshaft 16, which at rotation moves the piston 12 forwards and backwards in the cylinder c1, between a top dead centre TDC and a bottom dead centre BDC. In FIG. 3, the piston 12 is illustrated at a region of the top dead centre TDC.

The combustion engine 1 comprises an inlet system 14, which in the illustrated example engine is illustrated as an inlet duct. The inlet system 14 may further comprise an air filter, and according to some embodiments a throttle, a fuel injector, an air flow sensor, and the like. Moreover, the combustion engine 1 may comprise a turbocharger arranged to compress air to the inlet system 14 of the combustion engine 1. Thus, according to such embodiments, the inlet system 14 may be fluidically connected to a compressor of a turbocharger. The compressor may be connected to a shaft which is connected to a turbine of the turbocharger. The turbine may be arranged to be driven by the flow of gases from an exhaust outlet 26 of the combustion engine 1. The combustion engine 1 may comprise more than one turbocharger, wherein the turbochargers may be arranged in parallel or on series.

The combustion engine 1 further comprises at least one inlet valve 18 arranged in each cylinder c1, which at least one inlet valve 18 is connected with the inlet system 14. The combustion engine 1 further comprises an inlet valve control arrangement 22 configured to control each inlet valve 18 on the basis of a rotational position of the crankshaft 16. The combustion engine 1 further comprises at least one exhaust valve 24 arranged in each cylinder c1, which at least one exhaust valve 24 is connected with an exhaust outlet 26 of the combustion engine 1.

The combustion engine 1 further comprises an exhaust valve control arrangement 28 configured to control each exhaust valve 24 on the basis of the rotational position of the crankshaft 16. In FIG. 3, the inlet valve 18 and the exhaust valve 24 are illustrated in a respective closed position. In a closed position, each valve 18, 24 abuts against a respective valve seat to close a fluid connection between the cylinder c1 and the respective inlet system 14 and the exhaust outlet 26.

The inlet valve control arrangement 22 is arranged to control the at least one inlet valve 18 between the closed position and an open position by displacing the at least one inlet valve 18 in a direction into the cylinder c1. A fluid connection is thereby opened between the inlet system 14 and the cylinder c1. Likewise, the exhaust valve control arrangement 28 is arranged to control the at least one exhaust valve 24 between the closed position to an open position by displacing the at least one exhaust valve 24 in a direction into the cylinder c1. Thereby, a fluid connection is opened between the cylinder c1 and the exhaust outlet 26. Upon displacement of a valve 18, 24 from the closed position to the open position, the valve 18, 24 is lifted from its valve seat.

The combustion engine 1 further comprises a fuel injector 31 arranged to inject fuel directly into the cylinder c1. As mentioned above, according to the illustrated embodiments, the combustion engine 1 is a diesel engine, i.e., a type of compression ignition engine. According to further embodiments, the combustion engine may be an Otto engine with a spark-ignition device, wherein the Otto engine may be designed to run on gas, petrol, alcohol or similar volatile fuels or combinations thereof. Such fuel may be directly injected into the cylinder c1 using a fuel injector or may be supplied to incoming air prior to entering the cylinder c1, for example by a fuel injector arranged at an inlet duct of the combustion engine. The combustion engine 1 may comprise an exhaust after treatment system. The exhaust after treatment system may comprise one or more of a catalytic converter, a particulate filter, a Selective catalytic reduction (SCR) arrangement, a Diesel Oxidation Catalyst (DOC), a Lean NOx Trap (LNT) and a Three-Way Catalyst (TWC).

The exhaust valve control arrangement 28 and the inlet valve control arrangement 22 may each comprise one or more camshafts 71, 72 rotatably connected to the crankshaft 16 of the combustion engine 1. Moreover, the exhaust valve control arrangement 28 and the inlet valve control arrangement 22 may each comprise one or more arrangements, such as rocker arms 73, 74, for transferring movement of cam lobes of the camshafts 71, 72 to valve stems of the valves 18, 24 to an open position upon rotation of the respective camshaft 71, 72. According to further embodiments, the cam lobes of the camshafts 71, 72 of the combustion engine 1 may be arranged to displace valves 18, 24 to an open position by pressing onto valve stems of the valves 18, 24 upon rotation of the respective camshaft 71, 72.

The exhaust valve control arrangement 28 and/or the inlet valve control arrangement 22 may according to further embodiments comprise electric, pneumatic, or hydraulic actuators arranged to control valves on the basis of the rotational position of the crankshaft 16. The rotational position of the crankshaft 16 may be obtained using a crank angle sensor 29.

According to the illustrated embodiments, the exhaust valve control arrangement 28 comprises an exhaust valve phase-shifting device 30 configured to phase-shift control of the at least one exhaust valve 24 in relation to the crankshaft 16. Moreover, according to the illustrated embodiments, the inlet valve control arrangement 22 comprises an inlet valve phase-shifting device 32 configured to phase-shift control of the at least one inlet valve 18 in relation to the crankshaft 16.

The exhaust valve phase-shifting device 30 and the inlet valve phase-shifting device 32 may each comprise a hydraulic arrangement, for example using engine oil as hydraulic fluid, to phase-shift control of the valves 18, 24 in relation to the crankshaft 16. Such hydraulic arrangement may form part of a belt pulley, gear wheel, sprocket, or the like (not illustrated) arranged to transfer rotation from the crankshaft 16 to a camshaft 71, 72 of the exhaust valve control arrangement 28 and/or of the inlet valve control arrangement 22. The hydraulic arrangement may be arranged to regulate an angular relationship between a first portion of the belt pulley, gear wheel, sprocket, or the like, being connected to the crankshaft 16, and a second portion of the belt pulley, gear wheel, sprocket, or the like, being connected to the camshaft 71, 72, in order to phase-shift control of the at least one inlet valve 18 and/or the at least one exhaust valve 24. In embodiments wherein the exhaust valve control arrangement 28 and/or the inlet valve control arrangement 22 comprises electric, pneumatic, or hydraulic actuators, the phase-shift of control of the at least one inlet valve 18 and/or the at least one exhaust valve 24 may be performed in another manner, for example by an electronic phase-shift of control.

The exhaust valve control arrangement 28 of each cylinder c1 of the combustion engine 1 comprises a compression release braking arrangement b1. The compression release braking arrangements b1-b5 of all cylinders c1-c5 of the internal combustion engine 1 are schematically indicated in FIG. 2. Each compression release braking arrangement b1-b5 is capable of causing an additional valve lift event of at least one exhaust valve 24 of the cylinder c1-c5 when the compression release braking arrangement b1-b5 is activated. The additional valve lift event may be performed when the piston 12 of the cylinder c1-c5 is at a region of the top dead centre.

As can be seen in FIG. 3, according to the illustrated embodiments, the camshaft 72 of the exhaust valve control arrangement 28 has been provided with an additional cam lobe 72′. According to the illustrated embodiments, the compression release braking arrangement b1 is configured such that it does not transfer movement caused by the additional cam lobe 72′ to the at least one exhaust valve 24 when the compression release braking arrangement b1 is deactivated, i.e., not activated. Therefore, according to the illustrated embodiments, the compression release braking arrangement b1 is a type of lost motion arrangement. The compression release braking arrangement b1 is configured to transfer movement caused by the additional cam lobe 72′ to the at least one exhaust valve 24 upon activation. In this manner the at least one exhaust valve 24 is opened by the additional cam lobe 72′ when the compression release braking arrangement b1 is activated.

In more detail, according to the illustrated embodiments, the compression release braking arrangement b1 is of hydraulic type and comprises a hydraulic chamber and at least one valve, wherein the compression release braking arrangement b1 is activated by closing the at least one valve and is deactivated by opening the at least one valve. These components are not illustrated in FIG. 3 for reasons of brevity and clarity. Moreover, according to the illustrated embodiments, the compression release braking arrangements b1-b5 of the combustion engine 1 utilize the engine oil of the combustion engine 1 as a hydraulic fluid. However, according to further embodiments, the combustion engine 1 may comprise another type of compression release braking arrangement b1 than a hydraulic compression release braking arrangement b1.

As mentioned, each compression release braking arrangement b1-b5 is capable of causing an additional valve lift event of at least one exhaust valve 24 of the cylinder c1-c5 when the compression release braking arrangement b1-b5 is activated, wherein the additional valve lift event is performed at a region of the top dead centre of the piston 12 of the cylinder c1 c5. In this manner, a negative crankshaft torque is generated by the cylinder c1 because compressed gasses in the cylinder c1 during the compression stroke is released into the exhaust outlet 26 of the combustion engine 1 when the piston 12 is in the region of the top dead centre TDC. Thereby, the energy stored in the compressed gases during the compression stroke will not be returned to the crank shaft 16 in the subsequent expansion stroke, which increases the negative crankshaft torque generated by the cylinder c1.

The combustion engine 1 comprises a control arrangement 21. The control arrangement 21 is operably connected to each compression release braking arrangement b1-b5 of the combustion engine 1 and is capable of activating and deactivating each compression release braking arrangement b1-b5 of the combustion engine 1.

In this manner, the control arrangement 21 is capable of causing cylinders c1-c5 to operate in a compression release mode, i.e., in a mode in which compressed gasses in the cylinder c1 during the compression stroke is released into the exhaust outlet 26 of the combustion engine 1. According to the illustrated embodiments, the control arrangement 21 is configured to cause a cylinder to operate in the compression release mode by activating the compression release braking arrangement b1-b5 of the cylinder c1-c5. Moreover, according to the illustrated embodiments, the control arrangement 21 is configured to cancel the compression release mode of a cylinder c1-c5 by deactivating the compression release braking arrangement b1-b5 of the cylinder c1-c5.

The control arrangement 21 is also operably connected to each fuel injector i1-i5 of the combustion engine 1 and is configured to control the fuel injection performed by the fuel injector i1-i5 into the respective cylinder c1-c5. The control arrangement 21 may be configured to control a fuel injection amount and a fuel injection timing of each fuel injector i1-i5 of the combustion engine 1.

Obviously, no fuel is to be injected into a cylinder c1-c5 when the cylinder c1-c5 operating in the compression release mode. Therefore, according to embodiments herein, the control arrangement 21 is configured to operate a cylinder c1-c5 in the compression release mode by activating the compression release braking arrangement b1-b5 of the cylinder c1-c5 and by cancelling fuel injection into the cylinder c1-c5, i.e., such that no fuel is injected into the cylinder c1-c5.

Moreover, the control arrangement 21 is capable of causing cylinders c1-c5 of the combustion engine 1 to operate in a motoring mode, i.e., in a mode in which no fuel is injected into the cylinder c1-c5. Moreover, no compression release engine braking is performed in the motoring mode. Accordingly, as understood from the above, the control arrangement 21 operates a cylinder c1-c5 in the motoring mode by cancelling fuel injection into the cylinder c1-c5, such that no fuel is injected into the cylinder c1-c5, and by ensuring that the compression release braking arrangement b1-b5 of the cylinder c1-c5 is deactivated.

The motoring mode, as referred to herein, may also be referred to as a neutral motoring mode lacking combustion in the cylinder c1-c5 and being associated with a normal control of valves 18, 24 of the cylinder c1-c5. As understood from the above, the motoring mode of a cylinder c1-c5 generates a negative crankshaft torque to the crankshaft 16 of the combustion engine 1 because the piston 12 of the cylinder c1-c5 is forced to reciprocate between the bottom dead centre and the top dead centre without any combustion in the combustion phase. However, since the energy stored in the compressed gases during the compression stroke is at least partially returned to the crank shaft 16 in the subsequent expansion stroke, the negative crankshaft torque to the crankshaft 16 is lower when a cylinder c1-c5 is operating in the motoring mode than when the cylinder c1-c5 is operating in the compression release mode.

Moreover, the control arrangement 21 is capable of causing cylinders c1-c5 of the combustion engine 1 to operate in a power mode, i.e., in a mode in which fuel is injected into the cylinder c1-c5 to cause combustion therein to generate a positive crankshaft torque to the crankshaft 16 of the combustion engine 1. Obviously, no compression release engine braking is to be performed in a cylinder c1-c5 when the cylinder c1-c5 is operating in the power mode. Therefore, the control arrangement 21 is configured to operate a cylinder c1 c5 in the power mode by controlling the fuel injector i1-i5 to inject fuel into the cylinder c1 c5 while ensuring that the compression release braking arrangement b1-b5 is deactivated. The power mode, as referred to herein, may also be referred to as a power producing mode, a combustion mode, a power producing combustion mode, or the like.

The term “negative crankshaft torque” as used herein is intended to encompass a crankshaft torque having a direction and magnitude causing a braking, i.e., retardation of a vehicle 2, when the torque is transferred from the crankshaft 16 of the combustion engine 1 to one or more ground engaging wheels 47 of the vehicle 2 via a transmission of the vehicle. The direction of the negative crankshaft torque is opposite to a rotation direction of the crankshaft 16 obtained during running of the combustion engine 1. Likewise, the term “positive crankshaft torque” as used herein is intended to encompass a crankshaft torque having a direction and magnitude causing an acceleration in a forward moving direction of a vehicle 2, when the torque is transferred from the crankshaft 16 of the combustion engine 1 to one or more ground engaging wheels 47 of the vehicle 2 via a transmission of the vehicle. The direction of the positive crankshaft torque coincides with a rotation direction of the crankshaft 16 obtained during running of the combustion engine 1.

As is indicated in FIG. 3, the control arrangement 21 is operably connected to a control unit 60. The control arrangement 21 is configured to receive a compression release mode activation demand Cba or a compression release mode deactivation demand Cbd from the control unit 60. The compression release mode activation demand Cba is indicative of a demand to initiate compression release engine braking whereas the compression release mode deactivation demand Cbd is indicative of a demand to deactivate compression release engine braking.

The following is explained with simultaneous reference to FIG. 2 and FIG. 3. According to embodiments herein, the control arrangement 21 is configured to operate a first set s1 of cylinders c1-c3 of the plurality of cylinders c1-c5 in the compression release mode, operate a second set s2 of cylinders c4, c5 of the plurality of cylinders c1-c5 in a motoring mode, and initiate operation of a power mode of the second set s2 of cylinders c4, c5 of the plurality of cylinders c1-c5 upon receipt of the compression release mode deactivation demand Cbd.

In this manner, a quick reduction in negative crankshaft torque can be obtained upon receipt of the compression release mode deactivation demand Cbd. The quick reduction in negative crankshaft torque is advantageous when quickly wanting to reduce the negative crankshaft torque obtained during compression release engine braking. As mentioned, according to the illustrated embodiments, the compression release braking arrangements b1-b5 of the combustion engine 1 utilize the engine oil of the combustion engine 1 as a hydraulic fluid. Therefore, the compression release braking arrangements b1-b5 have a considerable deactivation time in case of low engine oil temperatures. This is because the viscosity of the engine oil is considerable higher at low temperatures as compared to higher temperatures. Therefore, normally, a longer duration of a deactivation phase of the compression release braking arrangement b1-b5 is obtained in case of a low temperature of the engine oil.

However, due to the control of the control arrangement 21 according to embodiments herein, an at least substantially instant reduction in negative crankshaft torque can be obtained upon receipt of the compression release mode deactivation demand Cbd. The compression release mode deactivation demand Cbd may be received from an actuator arranged in a driver environment of a vehicle 2 comprising the control arrangement 21, such as a brake pedal, or the like. As an alternative, or in addition, the compression release mode deactivation demand Cbd may be received from another type of system or arrangement of the vehicle 2 comprising the control arrangement 21, such as for example one or more of a system for operating the vehicle 2 in an at least partially autonomous manner, a cruise control system, a vehicle stability control system, an anti-lock braking system, or the like.

Similarly, the compression release mode activation demand Cba may be received from an actuator arranged in a driver environment of a vehicle 2 comprising the control arrangement 21, such as a brake pedal, or the like. As an alternative, or in addition, the compression release mode activation demand Cba may be received from another type of system or arrangement of the vehicle 2 comprising the control arrangement 21, such as for example one or more of a system for operating the vehicle 2 in an at least partially autonomous manner, a cruise control system, a vehicle stability control system, an anti-lock braking system, or the like.

In FIG. 2, first set s1 of cylinders c1-c3 is illustrated as comprising three cylinders c1-c3 whereas the second set of cylinders s2 is illustrated as comprising two cylinders c4, c5.

However, according to further embodiments, the first set s1 of cylinders may comprise one or more of the plurality of cylinders c1-c5 of the combustion engine 1 and the second set s2 of cylinders may comprise one or more of the plurality of cylinders c1-c5 of the combustion engine 1.

Moreover, according to the illustrated embodiments, the first set s1 of cylinders c1-c3 plus the second set s2 of cylinders c4, c5 equals the plurality of cylinders c1-c5 of the combustion engine 1, i.e., equals the total number of cylinders c1-c5 of the combustion engine 1. However, the sum of the first set s1 of cylinders c1-c3 and the second set s2 of cylinders c4, c5 may not be equal to the total number of cylinders c1-c5 of the combustion engine 1. Moreover, according to the illustrated embodiments, the cylinders c1-c3 of the first set s1 of cylinders c1-c3 are adjacent cylinders c1-c3 and the cylinders c4, c5 of the second set s2 of cylinders c4, c5 are also adjacent cylinders c4, c5. However, one or both of the first and second sets s1, s2 of cylinders c1-c5 may comprise non-adjacent cylinders among the plurality of cylinders c1-c5 of the combustion engine 1.

The cylinders c1-c3 of the first set s1 of cylinders c1-c3 are separate from the cylinders c4, c5 of the second set s2 of cylinders c4, c5, and vice versa. The first set s1 of cylinders c1 c3, as referred to herein, may also be referred to as a first portion of cylinders c1-c3 of the combustion engine 1. Likewise, the second set s2 of cylinders c4, c5, as referred to herein, may be referred to as a second portion of cylinders c4, c5 of the combustion engine 1, wherein each of the first and second portions of cylinders c1-c5 comprises at least one cylinder c1-c5 of the plurality of cylinders c1-c5 of the combustion engine 1.

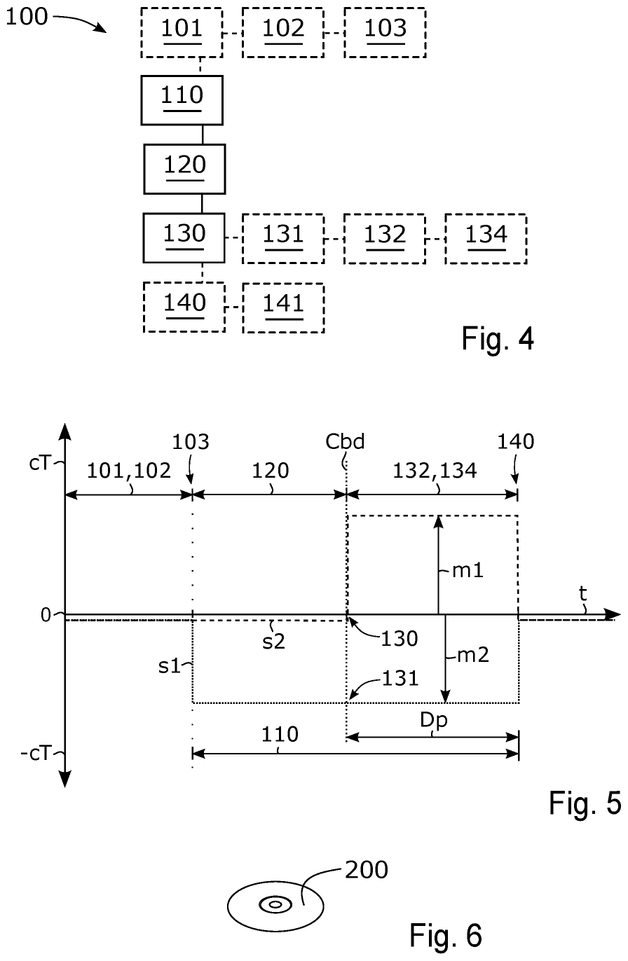

FIG. 4 schematically illustrates a method 100 of operating an internal combustion engine 1. The internal combustion engine 1 may be a combustion engine 1 according to the embodiments explained with reference to FIG. 1-FIG. 3. Therefore, in the following, simultaneous reference is made to FIG. 1-FIG. 4, if not indicated otherwise.

The method 100 is a method of operating an internal combustion engine 1, the internal combustion engine 1 comprising a plurality of cylinders c1-c5, wherein the method 100 comprises the steps of:
operating 110 a first set s1 of cylinders c1-c3 of the plurality of cylinders c1-c5 in a compression release mode,
operating 120 a second set s2 of cylinders c4, c5 of the plurality of cylinders c1-c5 in a motoring mode, and
initiating 130 operation of a power mode of the second set s2 of cylinders c4, c5 of the plurality of cylinders c1-c5 upon receipt of a compression release mode deactivation demand Cbd.

FIG. 5 illustrates a graph showing when some of the method steps of the method 100 illustrated in FIG. 4 are performed. Below, simultaneous reference is made to FIG. 1-FIG. 5, if not indicated otherwise. The graph illustrated in FIG. 5 comprises a first axis showing crankshaft torque cT,-cT supplied to the crankshaft 16 of the combustion engine 1 by cylinders c1-c5 of the combustion engine 1 and a second axis showing time t.

A receipt of a compression release mode deactivation demand Cbd is indicated in FIG. 5. As can be seen in FIG. 5, the step of operating 110 the first set s1 of cylinders c1-c3 in the compression release mode, and the step of operating 120 the second set s2 of cylinders c4, c5 in the motoring mode, are performed prior to the step of initiating 130 operation of a power mode of the second set s2 of cylinders c4, c5 of the plurality of cylinders c1-c5 upon receipt of the compression release mode deactivation demand Cbd.

According to the illustrated embodiments, the method 100 comprises the steps of, prior to the step of operating 110 the first set s1 of cylinders c1-c3 in the compression release mode and the step of operating 120 the second set s2 of cylinders c4, c5 in the motoring mode:
estimating 101 a duration of a deactivation phase Dp of a compression release mode, and
initiating 103 operation of the first set s1 of cylinders c1-c3 in the compression release mode and operation of the second set s2 of cylinders c4, c5 in the motoring mode if the estimated duration exceeds a threshold duration.

In the example illustrated in FIG. 5, the estimated duration exceeds the threshold duration.

The method 100 may comprise the step of, if the estimated duration is shorter than the threshold duration and if a compression release mode activation demand Cba is received:
initiating operation in a compression release mode of each of the plurality of cylinders c1-c5 of the internal combustion engine 1.

However, as mentioned, in the example illustrated in FIG. 5, the estimated duration exceeds the threshold duration and the step of initiating 103 operation of the first set s1 of cylinders c1 c3 in the compression release mode and operation of the second set s2 of cylinders c4, c5 in the motoring mode is performed by the method illustrated in FIG. 5.

The step of estimating 101 the duration of the deactivation phase Dp of the compression release mode may comprise the step of:
estimating 102 the duration of the deactivation phase Dp of the compression release mode based on data representative of at least one of a current coolant temperature of the combustion engine 1, a current oil temperature of the combustion engine 1, a current oil pressure of the combustion engine 1, a current ambient temperature, an elapsed time since a start-up of the combustion engine 1, an accumulated fuel flow since start-up of the combustion engine 1, a number of engine revolutions since start-up of the combustion engine 1, a distance travelled since start-up of the combustion engine 1, and energy obtained from the combustion engine since start-up of the combustion engine 1.

In this manner, a reliable estimation of the duration of the deactivation phase Dp of the compression release mode can be provided in a simple and reliable manner. This is because each of these types of data can, alone, or in combination, provide a reliable indication of the duration of the deactivation phase Dp of the compression release mode.

The dotted line indicated with reference sign “s1” in FIG. 5 indicates the crankshaft torque cT, −cT applied to the crankshaft 16 of the combustion engine 1 by the first set s1 of cylinders c1 −c3 during the time t. The dashed line indicated with reference sign “s2” in FIG. 5 indicates the crankshaft torque cT, −cT applied to the crankshaft 16 of the combustion engine 1 by the second set s2 of cylinders c4, c5 during the time t.

As seen in FIG. 5, the step of operating 110 the first set s1 of cylinders c1-c3 of the plurality of cylinders c1-c5 in the compression release mode causes the first set s1 of cylinders c1 c3 to apply a negative crankshaft torque −cT to the crankshaft 16 of the combustion engine 1 in a time period lasting from the step of initiating 103 operation of the first set s1 of cylinders c1-c3 in the compression release mode to the time t in which the compression release mode deactivation demand Cbd is received. Since the second set s2 of cylinders c4, c5 is operating in the motoring mode during this time period, the second set s2 of cylinders c4, c5 apply a slight negative crankshaft torque −cT to the crankshaft 16 of the combustion engine 1 during this time period.

Upon receipt of the compression release mode deactivation demand Cbd, the step of initiating 130 operation of the power mode of the second set s2 of cylinders c4, c5 causes the second set s2 of cylinders c4, c5 to apply a positive crankshaft torque cT to the crankshaft 16 of the combustion engine 1. Since the second set s2 of cylinders c4, c5 is operating in the motoring mode prior to the step of initiating 130 operation of the power mode of the second set s2 of cylinders c4, c5, an at least substantially instant increase can be obtained in crankshaft torque cT applied to the crankshaft 16 of the combustion engine 1 upon receipt of the compression release mode deactivation demand Cbd.

According to the embodiments illustrated in FIG. 4 and FIG. 5, the method 100 comprises the step of:
initiating 131 a deactivation of the compression release mode of the first set s1 of cylinders c1-c3 upon receipt of the compression release mode deactivation demand Cbd.

In FIG. 5, the deactivation phase Dp of the compression release mode of the first set s1 of cylinders c1-c3 is indicated. The deactivation phase Dp of the compression release mode of the first set s1 of cylinders c1-c3 follows the step of initiating 131 a deactivation of the compression release mode of the first set s1 of cylinders c1-c3. The deactivation phase Dp of the compression release mode of the first set s1 of cylinders c1-c3 may be defined as a phase starting with the step of initiating 131 a deactivation of the compression release mode and lasting until a 95% decrease in negative crankshaft torque-cT has been obtained. As explained above, the deactivation phase Dp of the compression release mode may be caused by time needed for evacuating a hydraulic fluid, such as engine oil, from the number of compression release braking arrangements b1-b5 of the combustion engine 1.

The duration of the deactivation phase Dp of the compression release mode may for example range from 0.2 seconds up to a couple of seconds, depending for example on the temperature of the hydraulic fluid used by compression release braking arrangements b1 b5. Such a duration of the deactivation phase Dp may impair the functionality of driving aid systems of the vehicle 2, such as an anti-lock braking system ABS, a system for operating the vehicle 2 in an at least partially autonomous manner, a cruise control system, a vehicle stability control system, and the like. Moreover, such a duration may impair the driving feel of the vehicle.

However, due to the at least substantially instant increase in crankshaft torque cT obtained by the step of initiating 130 operation of the power mode of the second set s2 of cylinders c4, c5, the negative crankshaft torque-cT can be compensated for during the deactivation phase Dp of the compression release mode of the first set s1 of cylinders c1-c3.

According to the embodiments illustrated in FIG. 4 and FIG. 5, the method 100 comprises the step of:
operating 132 the second set s2 of cylinders c4, c5 in the power mode during a deactivation phase Dp of the compression release mode of the first set s1 of cylinders c1-c3.

Moreover, according to the embodiments illustrated in FIG. 4 and FIG. 5, the step of operating 132 the second set s2 of cylinders c4, c5 in the power mode during the deactivation phase Dp comprises the step of:
controlling 134 operation of the second set s2 of cylinders c4, c5 to generate a positive crankshaft torque cT having a magnitude m1 of at least 25%, at least 50%, or at least 75% of the magnitude m2 of a negative crankshaft torque −cT generated by the first set s1 of cylinders c1-c3 during the deactivation phase Dp.

According to the embodiments illustrated in FIG. 5, the operation of the second set s2 of cylinders c4, c5 is controlled to generate a positive crankshaft torque cT having a magnitude m1 of approximately 112% of the magnitude m2 of a negative crankshaft torque-cT generated by the first set s1 of cylinders c1-c3 during the deactivation phase Dp. In this manner, the total output torque of the crankshaft 16 of the combustion engine 1 can be switched from a negative braking torque to a positive propulsion torque at least substantially instantly upon receipt of the compression release mode deactivation demand Cbd. The magnitude m1 of the positive crankshaft torque cT generated by the second set s2 of cylinders c4, c5 may be controlled by controlling a fuel injection amount and/or a fuel injection timing of fuel injectors i4, i5 of the second set s2 of cylinders c4, c5.

Due to the control of the combustion engine 1 according to embodiments herein, the functionality of driving aid systems of the vehicle 2, such as an anti-lock braking system ABS, a system for operating the vehicle 2 in an at least partially autonomous manner, a cruise control system, a vehicle stability control system, and the like, can be significantly improved. Moreover, by the control of the combustion engine 1 according to embodiments herein, the driving feel of the vehicle can be improved.

Furthermore, due to the control of the combustion engine 1 according to embodiments herein, compression release engine braking is allowed to be used in a wider range of situations and conditions, and compliance with legislation is facilitated while circumventing, or at least reducing, the need for further auxiliary brakes on the vehicle 2, such as one or more retarders, or the like.

In addition, since conditions are provided for a quick reduction in negative crankshaft torque-cT upon receipt of the compression release mode deactivation demand Cbd, conditions are provided for avoiding wheel slip, especially in slippery road conditions. In other words, due to the features, compression release engine braking can be performed in a safer and more efficient manner also in vehicles 2 comprising an anti-lock braking system.

According to the embodiments illustrated in FIG. 4 and FIG. 5, the method 100 comprises the step of:
cancelling 140 operation of the second set s2 of cylinders c4, c5 in the power mode at an end of the deactivation phase Dp of the compression release mode of the first set s1 of cylinders c1-c3.

As indicated in FIG. 4, the method 100 may comprise the step of:
initiating 141 operation of the first set s1 of cylinders c1-c3 in the power mode at an end of the deactivation phase Dp of the compression release mode of the first set s1 of cylinders c1-c3

The selection between the steps 140 and 141 may be made based on a propulsion demand, wherein step 140 may be selected in case of a neutral motoring propulsion demand, and wherein the step 141 may be selected in case of a positive torque propulsion demand. The propulsion demand may for example be received in the control arrangement 21 from the control unit 60 illustrated in FIG. 3.

It will be appreciated that the various embodiments described for the method 100 are all combinable with the control arrangement 21 as described herein. That is, the control arrangement 21 may be configured to perform any one of the method steps 101, 102, 103, 110, 120, 130, 131, 132, 134, 140, and 141 of the method 100.

FIG. 6 illustrates a computer-readable medium 200 comprising instructions which, when executed by a computer, cause the computer to carry out the method 100 according to some embodiments of the present disclosure. According to some embodiments, the computer-readable medium 200 comprises a computer program comprising instructions which, when the program is executed by a computer, cause the computer to carry out the method 100 according to some embodiments.

One skilled in the art will appreciate that the method 100 of operating an internal combustion engine 1 may be implemented by programmed instructions. These programmed instructions are typically constituted by a computer program, which, when it is executed in the control arrangement 21, ensures that the control arrangement 21 carries out the desired control, such as the method steps 101, 102, 103, 110, 120, 130, 131, 132, 134, 140, and 141 described herein. The computer program is usually part of a computer program product 200 which comprises a suitable digital storage medium on which the computer program is stored. The control arrangement 21 may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g., a memory card, a flash memory, a USB memory, a hard disc, or another similar volatile or non-volatile storage unit for storing data such as e.g., ROM (Read-Only Memory), PROM (Programmable Read-Only Memory), EPROM (Erasable PROM), EEPROM (Electrically Erasable PROM), etc. in different embodiments.

The control arrangement 21 is connected to components of the internal combustion engine 1 for receiving and/or sending input and output signals. These input and output signals may comprise waveforms, pulses, or other attributes which the input signal receiving devices can detect as information and which can be converted to signals processable by the control arrangement 21. These signals may then be supplied to the calculation unit. One or more output signal sending devices may be arranged to convert calculation results from the calculation unit to output signals for conveying to other parts of the vehicle's control system and/or the component or components for which the signals are intended. Each of the connections to the respective components of the internal combustion engine 1 for receiving and sending input and output signals may take the form of one or more from among a cable, a data bus, e.g., a CAN (controller area network) bus, a MOST (media orientated systems transport) bus or some other bus configuration, or a wireless connection.

In the embodiments illustrated, the internal combustion engine 1 comprises a control arrangement 21 but might alternatively be implemented wholly or partly in two or more control arrangements or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles and engines of the type here concerned are therefore often provided with significantly more control arrangements than depicted in FIG. 4, as one skilled in the art will surely appreciate.

The computer program product 200 may be provided for instance in the form of a data carrier carrying computer program code for performing at least some of the method steps 101, 102, 103, 110, 120, 130, 131, 132, 134, 140, and 141 according to some embodiments when being loaded into one or more calculation units of the control arrangement 21. The data carrier may be, e.g. a CD ROM disc, as is illustrated in FIG. 6, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 21 remotely, e.g., over an Internet or an intranet connection, or via other wired or wireless communication systems.

The compression release mode deactivation demand Cbd, as referred to herein, may also be referred to as a demand or request for deactivating or cancelling the compression release mode of the first set s1 of cylinders c1-c3.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method (100) of operating an internal combustion engine, the internal combustion engine comprising a plurality of cylinders,
wherein the method comprises the steps of:
operating a first set of cylinders of the plurality of cylinders in a compression release mode;
operating a second set of cylinders of the plurality of cylinders in a motoring mode; and
initiating operation of a power mode of the second set of cylinders of the plurality of cylinders upon receipt of a compression release mode deactivation demand

2. The method according to claim 1, wherein the method comprises the step of:
initiating a deactivation of the compression release mode of the first set of cylinders upon receipt of the compression release mode deactivation demand.

3. The method according to claim 2, wherein the method comprises the step of:
operating the second set of cylinders in the power mode during a deactivation phase (Dp) of the compression release mode of the first set of cylinders.

4. The method according to claim 3, wherein the method comprises the step of:
cancelling operation of the second set of cylinders, in the power mode at an end of the deactivation phase of the compression release mode of the first set of cylinders.

5. The method according to claim 3, wherein the step of operating the second set of cylinders in the power mode during the deactivation phase comprises the step of:
controlling operation of the second set of cylinders to generate a positive crankshaft torque having a magnitude of at least 25%, or at least 50%, of the magnitude of a negative crankshaft torque generated by the first set of cylinders during the deactivation phase.

6. The method according to claim 1, wherein the method comprises the steps of, prior to the step of operating the first set of cylinders in the compression release mode and the step of operating the second set of cylinders in the motoring mode:
estimating a duration of a deactivation phase of a compression release mode; and
initiating (103) operation of the first set of cylinders in the compression release mode and operation of the second set of cylinders in the motoring mode if the estimated duration exceeds a threshold duration.

7. The method according to claim 6, wherein the step of estimating the duration of the deactivation phase of the compression release mode comprises the step of:
estimating the duration of the deactivation phase of the compression release mode based on data representative of at least one of a current coolant temperature of the combustion engine, a current oil temperature of the combustion engine, a current oil pressure of the combustion engine, a current ambient temperature, an elapsed time since a start-up of the combustion engine, an accumulated fuel flow since start-up of the combustion engine, a number of engine revolutions since start-up of the combustion engine, a distance travelled since start-up of the combustion engine and energy obtained from the combustion engine since start-up of the combustion engine.

8. A computer program product stored on a non-transitory computer-readable medium, said computer program product for operating an internal combustion engine, where the internal combustion engine comprises a plurality of cylinders, wherein said computer program product comprising computer instructions to cause one or more computer processors to perform the following operations:
operate a first set of cylinders of the plurality of cylinders in a compression release mode;
operate a second set of cylinders of the plurality of cylinders in a motoring mode; and
initiate operation of a power mode of the second set of cylinders of the plurality of cylinders upon receipt of a compression release mode deactivation demand.

9. (canceled)

10. A control arrangement for an internal combustion engine, the internal combustion engine comprising a plurality of cylinders, wherein the control arrangement is configured to:
operate a first set of cylinders of the plurality of cylinders in a compression release mode;
operate a second set of cylinders of the plurality of cylinders in a motoring mode; and
initiate operation of a power mode of the second set of cylinders of the plurality of cylinders upon receipt of a compression release mode deactivation demand.

11. An internal combustion engine comprising a plurality of cylinders and a control arrangement, wherein said contral arrangement is configured to:
operate a first set of cylinders of the plurality of cylinders in a compression release mode;
operate a second set of cylinders of the plurality of cylinders in a motoring mode; and
initiate operation of a power mode of the second set of cylinders of the plurality of cylinders upon receipt of a compression release mode deactivation demand.

12. A vehicle comprising an internal combustion engine, wherein the internal combustion engine comprises plurality of cylinders and a control arrangement, wherein said control arrangement is configured to:
operate a first set of cylinders of the plurality of cylinders in a compression release mode;
operate a second set of cylinders of the plurality of cylinders in a motoring mode; and
initiate operation of a power mode of the second set of cylinders of the plurality of cylinders upon receipt of a compression release mode deactivation demand.
